(19) United States
(12) Patent Application Publication
(10) Pub. No.: US 2025/0236724 A1
(43) Pub. Date: Jul. 24, 2025

(54) Flexible Material Based On Resource Utilization Of Waste Finished Leathers And Waste Fabrics And Preparation Method Thereof

(71) Applicant: Xinji City Baolong Technology Co., Ltd., Xinji City (CN)

(72) Inventors: Hexiang Dong, Xinji City (CN); Di Ma, Xinji City (CN); Yunying Song, Xinji City (CN); Tong Yang, Xinji City (CN); Chao Zhu, Xinji City (CN)

(73) Assignee: Xinji City Baolong Technology Co., Ltd., Xinji City (CN)

(21) Appl. No.: 18/636,465

(22) Filed: Apr. 16, 2024

(30) Foreign Application Priority Data
Jan. 23, 2024 (CN) 202410093740.8

(51) Int. Cl. C08L 17/00; C08J 3/22; C08J 11/08

(52) U.S. Cl. CPC C08L 17/00; C08J 3/226; C08J 11/08; C08J 2317/00; C08J 2367/00; C08J 2391/00; C08J 2429/04; C08L 2205/035; C08L 2207/20; C08L 2310/00

(57) ABSTRACT

Provided are a flexible material based on resource utilization of waste finished leathers and waste fabrics and a preparation method thereof. The flexible material is prepared form raw materials including the following components in parts by weight: 50 parts to 70 parts of a waste rubber powder, 10 parts to 20 parts of a waste polyester nano-powder, 10 parts to 20 parts of a waste leather powder, and 8 parts to 12 parts of an epoxidized natural rubber (ENR) curing agent.

### CROSS REFERENCE TO RELATED APPLICATION

This application claims the benefit and priority of Chinese Patent Application No. 2024100937408 filed with the China National Intellectual Property Administration on Jan. 23, 2024, the disclosure of which is incorporated by reference herein in its entirety as part of the application.

### TECHNICAL FIELD

The present disclosure relates to the technical field of flexible material preparation, and more specifically to a flexible material based on resource utilization of waste finished leathers and waste fabrics and a preparation method thereof.

### BACKGROUND

With the development of society and economy, wastes generated by the clothing, footwear and boot industries has increased significantly. These wastes mainly include various types of finished leather products (such as leather shoes, belts, and bags) and fabric products (such as clothes and hats), which may be discarded after a certain period of use and become solid wastes. Currently, the main treatment methods for this type of wastes are landfill or incineration. However, these treatment methods cannot realize resource reuse, resulting in waste of resources and serious environmental pollution.

Accordingly, it is necessary to provide a flexible material based on the resource utilization of waste finished leathers and waste fabrics to comprehensively utilize the above wastes.

### SUMMARY

The present disclosure provides a flexible material based on resource utilization of waste finished leathers and waste fabrics and a preparation method thereof. The flexible material has wear resistance, high tear strength, and desirable elasticity.

In a first aspect, the present disclosure provides a flexible material based on resource utilization of waste finished leathers and waste fabrics, adopting the following technical solutions.

The flexible material based on resource utilization of waste finished leathers and waste fabrics is prepared from raw materials including the following components in parts by weight:

50 parts to 70 parts of a waste rubber powder, 10 parts to 20 parts of a waste polyester nano-powder, 10 parts to 20 parts of a waste leather powder, and 8 parts to 12 parts of an epoxidized natural rubber (ENR) curing agent.

In the technical solutions of the present disclosure, after each component is fully mixed, the waste rubber powder is fully reacted and cross-linked under the action of a vulcanizing agent and the ENR curing agent to form a three-dimensional network structure. Since waste polyester nano-powder contains a larger amount of polyester polymer molecules, and waste leather powder contains a larger amount of leather collagenous fiber, polyester polymer molecules from waste polyester nano-powder and leather collagenous fiber from waste leather powder are wrapped in the network structure. Rubber molecules and polyester polymer molecules interact to significantly enhance the strength (such as tensile strength, tear strength, and elongation at break) and wear resistance of the flexible material. The interaction between rubber molecules and leather collagenous fiber significantly improves elasticity and flexibility of the flexible material. The flexible material shows excellent mechanical strength, elasticity, and soft touch. The flexible material has the advantages of comfort, durability, and long life when being used to prepare products such as foot pads.

In some embodiments, a rubber molecule in the waste rubber powder has a molecular weight of 20,000 to 50,000; and the waste polyester nano-powder has a particle size of 50 nm to 100 nm.

In some embodiments, the waste rubber powder is prepared by a process including the following steps:
step 11, collecting a waste rubber, extracting the waste rubber by using supercritical carbon dioxide at a temperature of 30° C. to 40° C. under a pressure of 20 MPa to 30 MPa for 2 h to 4 h to obtain a primary rubber extract, and subjecting the primary rubber extract to vacuum distillation to recover a rubber solution, thereby obtaining a crude rubber product; where the supercritical carbon dioxide is further added with 0.5 vol. % to 2 vol. % of an emulsion solvent;
step 12, extracting the crude rubber product with another supercritical carbon dioxide at a temperature of 30° C. to 40° C. under a pressure of 20 MPa to 30 MPa for 2 h to 4 h to obtain a secondary rubber extract, and subjecting the secondary rubber extract to distillation to remove a solvent, thereby obtaining a refined rubber product; where the another supercritical carbon dioxide is further added with 0.5 vol. % to 2 vol. % of the emulsion solvent; and
step 13, subjecting the refined rubber product to cryogenic grinding in liquid nitrogen to obtain a ground rubber product, subjecting the ground rubber product to polycondensation in the emulsion solvent at a temperature of 60° C. to 100° C. for 2 h to 4 h, terminating the polycondensation to obtain a polycondensation product, and subjecting the polycondensation product to a post-treatment to obtain a rubber powder with a rubber molecular weight of 20,000 to 50,000;
wherein the emulsion solvent is selected from the group consisting of ethanol and acetone.

There may be other non-rubber components (such as fillers and initiator residues) in the waste rubber, and such impurities generally have a certain negative effect on rubber properties. By adopting the above technical solutions, a target rubber product is extracted by a solvent extraction system using the supercritical CO2 as a main component and the emulsion solvent as a supplement. This extraction system improves a dissolving ability of rubber to achieve efficiently extracting and purifying the target rubber product. The vacuum distillation significantly reduces damage to rubber molecules while ensuring rapid evaporation of the solvent. Further, low-molecular-weight rubber molecules are polymerized through polycondensation to obtain high-molecular-weight rubber molecules, making molecular weight distribution of the rubber molecules narrower and significantly improving rubber properties. The main reasons why purer rubber and narrower molecular weight distribution are beneficial to improving the physical properties of the final product are as follows: 1. A negative impact of impurities is reduced. 2. There is a more uniform molecular structure, making the material more isotropic and the distribution of performance parameters more concentrated. 3. Under the condition that the molecular weight distribution is narrowed, a reaction between the cross-linking agent and the rubber molecular segments is more controllable and stable, making it easier to obtain an ideal network structure. 4. A microstructure of rubber molecules is completer and more regular, reducing the occurrence of defects. 5. Enhanced properties: under the condition that the molecular weight and components are highly consistent, the materials show more obvious commonalities, and certain properties (such as strength and toughness) could be greatly improved. Therefore, the rubber powder with excellent performance and stability could be obtained through the above technical solutions.

In some embodiments, the process further includes stirring at a speed of 300 rpm to 500 rpm during the extracting in steps 11 and 12, and stirring at a speed of 100 rpm to 300 rpm during polycondensation in step 13.

In some embodiments, the extracting by using supercritical carbon dioxide in step 11 is conducted at a flow rate of 2 to 4 times a weight of the raw material per hour.

In the above technical solutions, the flow rate of carbon dioxide is set based on the weight of the raw material, that is, the weight of the waste rubber. For example, if the waste rubber is 10 kg, the carbon dioxide has a flow rate of (20-40) kg/h during the extracting.

In some embodiments, the extracting by using supercritical carbon dioxide in step 12 is conducted at a flow rate of 2 to 4 times a weight of the raw material per hour.

In the above technical solutions, the flow rate of carbon dioxide is set based on the weight of the raw material, that is, the weight of the crude rubber product. For example, if the crude rubber product is 10 kg, the carbon dioxide has a flow rate of (20-40) kg/h during the extracting.

In some embodiments, the vacuum distillation in step 11 includes the following steps:
filtering the primary rubber extract to obtain a precipitate and a filtrate, decompressing the precipitate at a temperature of 60° C. to 80° C. to an absolute pressure, heating the filtrate to boiling, adjusting a temperature of a resulting gas phase to at a temperature of 68° C. to 72° C. and a resulting liquid phase to a temperature of 76° C. to 80° C., and recovering a solvent to obtain the crude rubber product in a form of a dry powder.

In some embodiments, for subjecting the secondary rubber extract to distillation to remove the solvent in step 12, the distillation is conducted by another vacuum distillation at a temperature of less than 80° C.

In some embodiments, terminating the polycondensation in step 13 is conducted by adding a terminator; and the terminator is selected from the group consisting of a phenolic compound and an inorganic phenolic compound.

In some embodiments, the phenolic compound is one or more selected from the group consisting of catechol, di-tert-butylphenol, phenol, and p-hydroxyphenol; and the inorganic phenolic compound may be layered ammonium silicate.

In some embodiments, under the condition that the terminator is catechol, an addition amount of the catechol is in a range of 0.1 wt % to 0.3 wt % of the refined rubber product. In some embodiments, under the condition that the terminator is di-tert-butylphenol, an addition amount of the di-tert-butylphenol is in a range of 0.1 wt % to 0.2 wt % of the refined rubber product. In some embodiments, under the condition that the terminator is phenol, an addition amount of the phenol is in a range of 0.2 wt % to 0.5 wt % of the refined rubber product. In some embodiments, under the condition that the terminator is layered ammonium silicate, an addition amount of the layered ammonium silicate is in a range of 0.3 wt % to 0.5 wt % of the refined rubber product.

In some embodiments, the post-treatment includes filtration, deodorization, and drying of a polycondensation product.

In some embodiments, after mixing the emulsion solvent and the refined rubber product to obtain a mixture in step 13, a mass percentage of the refined rubber product in the mixture is in a range of 10 wt % to 30 wt %.

In some embodiments, the waste polyester nano-powder is prepared by a process including the following steps.
step 21, collecting a crushed waste polyester and mixing with a purification solvent to obtain a mixture, extracting the mixture at a temperature of 60° C. to 90° C. for 2 h to 4 h to obtain a polyester extract; where a mass ratio of the crushed waste polyester to the purification solvent is in a range of 1:(10-15);
step 22, filtering the polyester extract to obtain a precipitate, and subjecting the precipitate to solvent removal and drying in sequence to obtain a crude polyester powder;
step 23, mixing the crude polyester powder with another purification solvent to obtain a blend, extracting the blend at a temperature of 60° C. to 90° C. for 0.5 h to 1 h to obtain a crude polyester powder extract; where a mass ratio of the crude polyester powder to the another purification solvent is in a range of 1:(10-15);
step 24, subjecting the crude polyester powder extract to solid-liquid separation to obtain another precipitate, and subjecting the another precipitate to another solvent removal and another drying in sequence to obtain a preliminary purified polyester powder; and
step 25, repeating steps 23 to 24 until a polyester powder with uniform texture and appearance is obtained.

By adopting the above technical solutions, the waste polyester nano-powder with a particle size of 50 nm to 200 nm is finally prepared. At least 98% of the waste polyester nano-powder is distributed in a particle size range of 50 nm to 200 nm, and a small amount of or even no powder particles have a larger particle size.

In some embodiments, the purification solvent is one or more selected from the group consisting of DCM, TCM, chloroform, and isopropyl alcohol, preferably isopropyl alcohol.

In some embodiments, the solvent removal in step 22 includes: removing the solvent at a distillation temperature of less than 100° C. under 20 KPa to 50 KPa; and the drying in step 22 is conducted at 45° C. to 75° C. for 6 h to 10 h.

In some embodiments, the waste leather powder in prepared by a process including the following steps: collecting the waste finished leathers and cotton fabrics, removing a fabric base layer, crushing a remaining surface leather matrix to obtain a crushed product, and sieving the crushed product to obtain the waste leather powder with 30 mesh to 50 mesh.

In some embodiments, the ENR curing agent is prepared from start materials including the following components in parts by weight:
45 parts to 55 parts of an epoxidized soybean oil, 45 parts to 55 parts of citric acid, 5 parts to 15 parts of a polyvinyl alcohol (PVA), 5 parts to 10 parts of a thickener, and 70 parts to 90 parts of an organic solvent; and in some embodiments, the thickener is selected from the group consisting of guar gum and gum arabic.

By adopting the above technical solutions, the citric acid provides carboxyl groups (—COOH) and hydroxyl groups (—OH), while the epoxidized soybean oil provides epoxy groups (—O—); there are carbon-carbon double bonds in the rubber molecules of waste rubber powder (natural rubber), such that the three could undergo epoxidation reactions. During the reaction, the epoxy groups react chemically with the carboxyl groups and the carbon-carbon double bonds, which is a main way of cross-linking. At the same time, the hydroxyl groups could also participate in the reaction to promote further cross-linking and epoxidation. The PVA and thickener could stabilize and protect the micelles of the curing agent, refine the particle size distribution of the curing agent particles, and prevent excessive agglomeration of the curing agent particles, thereby improving the dispersion of ENR curing agent particles to prepare micron-sized ENR curing agent particles that are uniformly dispersed and have desirable stability.

In some embodiments, the ENR curing agent is prepared by a process including the following steps.
step 31, dissolving the citric acid in an organic solvent to obtain a citric acid solution;
step 32, mixing the citric acid solution, the PVA, the thickener, and the epoxidized soybean oil at a temperature of 50° C. to 70° C. under a speed of 8,000 rpm to 12,000 rpm, and subjecting a resulting mixture to emulsification to obtain an emulsion; and
step 33, stirring the emulsion at a temperature of 75° C. to 85° C. until the organic solvent evaporates to obtain a crude ENR curing agent; and subjecting the crude ENR curing agent to separation and drying to obtain the ENR curing agent.

By adopting the above technical solutions, first the citric acid is dissolved in the organic solvent to fully activate the acid molecules. Through high-speed shearing, the ENR curing agent in a microscopic solid state is broken into micron particles with a diameter of 1 μm to 1,000 μm without adding other surfactants or stabilizers, and the particles are dispersed evenly and stably. In this process, the adjustment and stabilization of a particle size of the ENR curing agent mainly relies on natural rubber materials (namely the thickener) such as PVA and guar gum. Specifically, the PVA could be adsorbed to a surface of ENR curing agent particles to play a protective and stabilizing role; the thickener such as guar gum could thicken the suspension, increase the shear colloid force between non-solid ENR curing agent particles, and prevent excessive agglomeration between ENR curing agent particles. In other words, high-speed shearing ensures that it is broken into micron levels; the PVA and thickener enable micron-sized ENR curing agent particles to be dispersed evenly and stably through adsorption and thickening.

In a second aspect, the present disclosure provides a method for preparing the flexible material based on resource utilization of waste finished leathers and waste fabrics, adopting the following technical solutions.

The method for preparing the flexible material based on resource utilization of waste finished leathers and waste fabrics includes the following steps:
mixing the waste rubber powder, the waste polyester nano-powder, the waste leather powder, and the ENR curing agent according to proportions for 10 min to 20 min to obtain a rubber compound; and
subjecting the rubber compound to calendering or hot-pressed molding at a temperature of 110° C. to 130° C. to obtain a molding material, and curing the molding material for 10 min to 30 min to obtain the flexible material.

Some embodiments of the present disclosure have the following beneficial effects.

1. Compared with the existing technology, the present disclosure has the following advantages. 1). In the present disclosure, waste materials such as waste finished leather, cotton fabrics, and polyester from clothing, shoes and boots could be effectively recycled, and comprehensively utilized to prepare flexible materials. The present disclosure allows the full use of recycled materials (including waste finished leather, cotton fabrics, polyester and other scraps) as raw materials to achieve the reuse of these waste resources, thereby reducing environmental pollution and resource waste. 2). The curing agent uses an all-green epoxidized soybean oil and citric acid curing system. The raw materials are naturally available, easy to handle, and more environmental-friendly. Therefore, the raw materials and curing system according to the present application have low cost, simple production equipment, and simple and easy processing technology, thus being conducive to popularization and application, and especially suitable for production and processing of small and medium-sized enterprises. 3). The product according to the present disclosure has the flexibility, ductility, and high elasticity of both rubber and plastic, and belonging to a new type of polymer material. This material is superior to conventional rubber and plastic materials in terms of density, strength, elongation at break and other indicators, and could replace a variety of synthetic material products and has a wide range of applications. 4. The flexible material according to the present disclosure uses natural polymer materials, which cloud be completely degraded and will not produce “white pollution”; after a service life of flexible materials is over, the flexible material could be directly crushed and reused to achieve a circular economy without environmental impact.

2. The flexible material according to the present disclosure has high tear strength, wear resistance, and desirable elasticity.

3. In the present disclosure, a solvent extraction system based on supercritical CO2 as the main solvent and emulsion solvent as the auxiliary solvent is used to extract the target rubber product, thereby obtaining rubber particles composed of high-molecular-weight rubber molecules with a narrow molecular weight distribution.

### DETAILED DESCRIPTION OF THE EMBODIMENTS

The present disclosure will be further described in detail below in conjunction with examples. It should be noted that where specific conditions are not specified in the following examples, conventional conditions or conditions recommended by the manufacturer are followed. The raw materials used in the following examples may be obtained from commonly available sources unless otherwise specified.

### Preparation Examples of Waste Rubber Powder

The following preparation examples 1 to 3 were preparation examples of a waste rubber powder and specifically as follows:

### Preparation Example 1

A method for preparing the waste rubber powder was conducted as follows.

Step 11. 10 kg of waste rubber was collected and extracted by using supercritical carbon dioxide with a flow rate of 20 kg/h for 4 h at 30° C. under 20 MPa, while stirring at a speed of 300 rpm, to obtain a primary rubber extract, where 0.5 vol. % acetone was added to the supercritical carbon dioxide during the extraction. The primary rubber extract was subjected to vacuum distillation to recover a rubber solution as follows: the primary rubber extract was filtered to obtain a precipitate, and the precipitate (containing a certain amount of liquid) was decompressed at 60° C. to an absolute pressure (that is, the external environment was at a standard atmospheric pressure, and the absolute pressure was 1 atm, and the gauge pressure was 0 Pa), and a resulting filtrate was heated to boiling, the temperature of a resulting gas phase was adjusted to 68° C. and the temperature of a resulting liquid phase was adjusted to 80° C., and the solvent was recovered to obtain 8.5 kg of a crude rubber product in a form of a dry powder.

Step 12. 8.5 kg of the crude rubber product was extracted by using supercritical carbon dioxide with a flow rate of 17 kg/h for 4 h at 30° C. under 20 MPa, while stirring at a speed of 300 rpm, to obtain a secondary rubber extract, where 0.5 vol. % acetone was added to the supercritical carbon dioxide during the extraction. The secondary rubber extract was heated at 75° C. to remove the solvent by distillation, obtaining 6.5 kg of a refined rubber product.

Step 13. 6.5 kg of the refined rubber product was subjected to cryogenic grinding by using liquid nitrogen, and 58.5 kg of acetone was then added thereto. After that, polycondensation was conducted at 60° C. and a stirring speed of 100 rpm for 4 h, and catechol with an amount of 0.2 wt % of the refined rubber product was then added thereto to terminate the polycondensation. A resulting polycondensation product was filtered, deodorized, and dried in sequence, obtaining 5.0 kg of the waste rubber powder with a rubber molecular weight of 20,000 to 50,000.

### Preparation Example 2

A method for preparing the waste rubber powder was conducted as follows.

Step 11. 10 kg of waste rubber was collected and extracted by using supercritical carbon dioxide with a flow rate of 30 kg/h for 3 h at 35° C. under 25 MPa, while stirring at a speed of 400 rpm, to obtain a primary rubber extract, where 1 vol. % ethanol was added to the supercritical carbon dioxide during the extraction. The primary rubber extract was subjected to vacuum distillation to recover a rubber solution as follows: the primary rubber extract was filtered to obtain a precipitate, and the precipitate (containing a certain amount of liquid) was decompressed at 70° C. to an absolute pressure (that is, the external environment was a standard atmospheric pressure, and the absolute pressure was 1 atm, and the gauge pressure was 0 Pa), and a resulting filtrate was heated to boiling, the temperature of a resulting gas phase was adjusted to 70° C. and the temperature of a resulting liquid phase was adjusted to 78° C., and the solvent was recovered to obtain 9.2 kg of a crude rubber product in a form of a dry powder.

Step 12. 9.3 kg of the crude rubber product was extracted by using the supercritical carbon dioxide with a flow rate of 30 kg/h for 3 h at 35° C. under 25 MPa, while stirring at a speed of 400 rpm, to obtain a secondary rubber extract, where 1 vol. % ethanol was added to the supercritical carbon dioxide during the extraction. The secondary rubber extract was heated at 70° C. to remove the solvent by distillation, obtaining 7.9 kg of a refined rubber product.

Step 13. 7.9 kg of the refined rubber product was subjected to cryogenic grinding by using liquid nitrogen, and 31.6 kg of ethanol was then added thereto. After that, polycondensation was conducted at 80° C. and a stirring speed of 200 rpm for 3 h, and di-tert-butylphenol with an amount of 0.15 wt % of the refined rubber product was then added thereto to terminate the polycondensation. A resulting polycondensation product was filtered, deodorized, and dried in sequence, obtaining 6.3 kg of the waste rubber powder with a rubber molecular weight of 20,000 to 50,000.

### Preparation Example 3

A method for preparing the waste rubber powder was conducted as follows.

Step 11. 10 kg of waste rubber was collected and extracted by using supercritical carbon dioxide with a flow rate of 40 kg/h for 2 h at 40° C. under 30 MPa, while stirring at a speed of 500 rpm, to obtain a primary rubber extract, where 2 vol. % acetone was added to the supercritical carbon dioxide during the extraction. The primary rubber extract was subjected to vacuum distillation to recover a rubber solution as follows: the primary rubber extract was filtered to obtain a precipitate, and the precipitate (containing a certain amount of liquid) was decompressed at 80° C. to an absolute pressure (that is, the external environment was a standard atmospheric pressure, and the absolute pressure was 1 atm, and the gauge pressure was 0 Pa), and a resulting filtrate was heated to boiling, the temperature of a resulting gas phase was adjusted to 72° C. and the temperature of a resulting liquid phase was adjusted to 76° C., and the solvent was recovered to obtain 8. 1 kg of a crude rubber product in a form of a dry powder.

Step 12. 8.1 kg of the crude rubber product was extracted by using the supercritical carbon dioxide with a flow rate of 32.4 kg/h for 2 h at 40° C. under 30 MPa, while stirring at a speed of 500 rpm, to obtain a secondary rubber extract, where 2 vol. % acetone was added to the supercritical carbon dioxide during the extraction. The secondary rubber extract was heated at 78° C. to remove the solvent by distillation, obtaining 7.2 kg of a refined rubber product.

Step 13. 7.2 kg of the refined rubber product was subjected to cryogenic grinding by using liquid nitrogen, and 16.8 kg of ethanol was then added thereto. After that, polycondensation was conducted at 100° C. and a stirring speed of 300 rpm for 2 h, and phenol with an amount of 0.4 wt % of the refined rubber product was then added thereto to terminate the polycondensation. A resulting polycondensation product was filtered, deodorized, and dried in sequence, obtaining 5.6 kg of the waste rubber powder with a rubber molecular weight of 20,000 to 50,000.

### Preparation Examples of Waste Polyester Nano-Powder

The following preparation examples 4 to 6 were preparation examples of a waste polyester nano-powder, where waste polyester materials are derived from waste polyester clothes and old cloth. The preparation examples are as follows.

### Preparation Example 4

A method for preparing the waste polyester nano-powder was conducted as follows.

Step 21. 2 kg of a crushed waste polyester material was collected and mixed with 20 kg of TCM, then extracted at 60° C. for 4 h while stirring to obtain a polyester extract.

Step 22. The polyester extract was filtered, all the resulting precipitates were subjected to distillation at 80° C. under 20 KPa to remove the solvent, and then dried at 45° C. for 10 h to obtain a crude polyester powder.

Step 23. 1 kg of the crude polyester powder was mixed with 10 kg of TCM, and then extracted at 60° C. for 1 h while stirring, to obtain a crude polyester powder extract.

Step 24. The crude polyester powder extract was filtered. All the resulting precipitates were subjected to distillation at 80° C. under 20 KPa to remove the solvent, and then dried at 45° C. for 10 h to obtain a preliminary purified polyester powder.

Step 25. Steps 23 to 24 were repeated until the waste polyester nano-powder was obtained with uniform texture and appearance, which was milky white and opaque.

### Preparation Example 5

A method for preparing the waste polyester nano-powder was conducted as follows.

Step 21. 2 kg of a crushed waste polyester material was collected and mixed with 24 kg of isopropyl alcohol, and then extracted at 75° C. for 3 h while stirring to obtain a polyester extract.

Step 22. The polyester extract was filtered, all the resulting precipitates were subjected to distillation at 85° C. under 40 KPa to remove the solvent, and then dried at 60° C. for 8 h to obtain a crude polyester powder.

Step 23. 1 kg of the crude polyester powder was mixed with 12 kg of isopropyl alcohol, and then extracted at 75° C. for 45 min while stirring, to obtain a crude polyester powder extract.

Step 24. The crude polyester powder extract was filtered. All the resulting precipitates were subjected to distillation at 85° C. under 40 KPa to remove the solvent, and then dried at 60° C. for 8 h to obtain a preliminary purified polyester powder.

Step 25. Steps 23 to 24 were repeated until the waste polyester nano-powder was obtained with uniform texture and appearance, which was milky white and opaque. 99% of the powder particles in the waste polyester nano-powder were distributed in a particle size range of 50 nm to 200 nm, and powder particles having a particle size greater than 200 nm were in a small amount and could be removed through sieving.

### Preparation Example 6

A method for preparing the waste polyester nano-powder was conducted as follows.

Step 21. 2 kg of a crushed waste polyester material was collected and mixed with 20 kg of chloroform, and then extracted at 90° C. for 2 h while stirring to obtain a polyester extract.

Step 22. The polyester extract was filtered, all the resulting precipitates were subjected to distillation at 75° C. under 50 KPa to remove the solvent, and then dried at 75° C. for 6 h to obtain a crude polyester powder.

Step 23. 1 kg of the crude polyester powder was mixed with 10 kg of chloroform, and then extracted at 90° C. for 0.5 h while stirring, to obtain a crude polyester powder extract.

Step 24. The crude polyester powder extract was filtered. All the resulting precipitates were subjected to distillation at 75° C. under 50 KPa to remove the solvent, and then dried at 75° C. for 6 h to obtain a preliminary purified polyester powder.

Step 25. Steps 23 to 24 were repeated until the waste polyester nano-powder was obtained with uniform texture and appearance, which was milky white and opaque.

### Preparation Examples of ENR Curing Agent

The following Preparation Examples 7 to 9 were preparation examples of the ENR curing agent. In the following preparation examples, epoxidized soybean oil was specifically epoxidized soybean oil acrylate, with a CAS number of 8013-07-8; PVA was specifically purchased from 1. Xinlian Chemical, with a product number of PVA-1701; the gum arabic was specifically purchased from Shanghai Qiyin Chemical Industry, with a product number of arabic gum-5003; the guar gum was specifically purchased from Samsung Fine Chemicals, with a product number of guar gum-1005. The preparation examples are as follows.

### Preparation Example 7

The ENR curing agent was prepared from raw materials consisting of the following components: 450 g of epoxidized soybean oil, 450 g of citric acid, 50 g of PVA, 50 g of gum arabic, and 700 g of ethanol.

A method for preparing the ENR curing agent was conducted as follows.

Step 31: All citric acid was dissolved in all ethanol, and dispersed ultrasonically at room temperature for 30 min to fully activate citric acid molecules, so as to obtain a citric acid solution.

Step 32: the citric acid solution was heated to 70° C., and a high-shear pulping machine was then started and set a rotation speed of 8,000 rpm. After that, all the epoxidized soybean oil, PVA, and guar gum were added into the heated citric acid solution and stirred for 10 min to fully emulsify the two phases to obtain an emulsion.

Step 33: The emulsion was heated to 75° C. and stirred for 2.5 h to gradually evaporate the ethanol and gradually generate a micron-sized crude ENR curing agent. The curing agent particles were separated from the crude ENR curing agent by using a high-speed centrifuge, and then vacuum dried for 8 h, obtaining the ENR curing agent.

### Preparation Example 8

The ENR curing agent was prepared from raw materials consisting of the following components: 500 g of epoxidized soybean oil, 500 g of citric acid, 100 g of PVA, 80 g of guar gum, and 800 g of ethanol.

A method for preparing the ENR curing agent was conducted as follows.

Step 31: All citric acid was dissolved in all ethanol, and dispersed ultrasonically at room temperature for 30 min to fully activate citric acid molecules, so as to obtain a citric acid solution.

Step 32: the citric acid solution was heated to 60° C., and a high-shear pulping machine was then started and set a rotation speed of 10,000 rpm. After that, all the epoxidized soybean oil, PVA, and guar gum were added into the heated citric acid solution and stirred for 10 min to fully emulsify the two phases to obtain an emulsion.

Step 33: The emulsion was heated to 80° C. and stirred for 3 h to gradually evaporate the ethanol and gradually generate a micron-sized crude ENR curing agent. The curing agent particles were separated from the crude ENR curing agent by using a high-speed centrifuge, and then vacuum dried for 8 h, obtaining the ENR curing agent.

### Preparation Example 9

The ENR curing agent was prepared from raw materials consisting of the following components: 550 g of epoxidized soybean oil, 550 g of citric acid, 150 g of PVA, 100 g of guar gum, and 900 g of ethanol.

A method for preparing the ENR curing agent was conducted as follows.

Step 31: All citric acid was dissolved in all ethanol, and dispersed ultrasonically at room temperature for 30 min to fully activate citric acid molecules, so as to obtain a citric acid solution.

Step 32: the citric acid solution was heated to 50° C., and a high-shear pulping machine was then started and set a rotation speed of 12,000 rpm. After that, all the epoxidized soybean oil, PVA, and guar gum were added into the heated citric acid solution and stirred for 10 min to fully emulsify the two phases to obtain an emulsion.

Step 33: The emulsion was heated to 85° C. and stirred for 3.5 h to gradually evaporate the ethanol and gradually generate a micron-sized crude ENR curing agent. The curing agent particles were separated from the crude ENR curing agent by using a high-speed centrifuge, and then vacuum dried for 8 h, obtaining the ENR curing agent.

### Preparation Examples of Waste Leather Powder

The following Preparation Example 10 was a preparation example of the waste leather powder.

### Preparation Example 10

A method for preparing the waste leather powder was conducted as follows: the waste finished leathers and cotton fabrics were collected, and a fabric base layer was removed. A remaining surface leather matrix was crushed, and then sieved to obtain the waste leather powder of 30 mesh to 50 mesh.

### EXAMPLES

### Example 1

A flexible material based on resource utilization of waste finished leathers and waste fabrics was prepared from raw materials consisting of 500 g of a waste rubber powder, 100 g of a waste polyester nano-powder, 100 g of a waste leather powder, and 80 g of an ENR curing agent. The waste rubber powder was prepared from Preparation Example 1, the waste polyester nano-powder was prepared from Preparation Example 4, the waste leather powder was prepared from Preparation Example 10, and the ENR curing agent was prepared from Preparation Example 7.

The method for preparing the flexible material based on resource utilization of waste finished leathers and waste fabrics was conducted as follows.

The waste rubber powder, the waste polyester nano-powder, the waste leather powder, and the ENR curing agent were mixed according to the above proportions at 80° C. for 10 min to be uniform, obtaining a rubber compound; and

the rubber compound was subjected to calendering (into a sheet form) at 110° C., and then cured for 30 min to obtain the flexible material.

### Example 2

A flexible material based on resource utilization of waste finished leathers and waste fabrics was prepared from raw materials consisting of the following components.

600 g of a waste rubber powder, 150 g of a waste polyester nano-powder, 150 g of a waste leather powder, and 100 g of an ENR curing agent. The waste rubber powder was prepared from Preparation Example 2, the waste polyester nano-powder was prepared from Preparation Example 5, the waste leather powder was prepared from Preparation Example 10, and the ENR curing agent was prepared from Preparation Example 8.

A method for preparing the flexible material based on resource utilization of waste finished leathers and waste fabrics was conducted as follows.

The waste rubber powder, the waste polyester nano-powder, the waste leather powder, and the ENR curing agent were mixed according to the above proportions at 90° C. for 15 min to be uniform, obtaining a rubber compound; and

the rubber compound was subjected to hot-pressed molding (into a sheet form) at 120° C. under 15 MPa, and then cured for 20 min to obtain the flexible material.

### Example 3

A flexible material based on resource utilization of waste finished leathers and waste fabrics was prepared from raw materials consisting of the following components.

700 g of a waste rubber powder, 200 g of a waste polyester nano-powder, 200 g of a waste leather powder, and 120 g of an ENR curing agent. The waste rubber powder was prepared from Preparation Example 3, the waste polyester nano-powder was prepared from Preparation Example 6, the waste leather powder was prepared from Preparation Example 10, and the ENR curing agent was prepared from Preparation Example 9.

A method for preparing the flexible material based on resource utilization of waste finished leathers and waste fabrics was conducted as follows.

The waste rubber powder, the waste polyester nano-powder, the waste leather powder, and the ENR curing agent were mixed according to the above proportions at 100° C. for 15 min to be uniform, obtaining a rubber compound; and

the rubber compound was subjected to hot-pressed molding (into a sheet form) at 130° C. and 13 MPa, and then cured for 10 min to obtain the flexible material.

### Examples 4 to 9 and Comparative Examples 1 to 7

The following examples differed from Example 2 in that the amounts of raw materials used to prepare the flexible material were different, as shown in Table 1.

TABLE 1
Amounts of raw materials used in different examples

| | | Waste | Waste | |
|---|---|---|---|---|
| | Waste rubber | polyester | leather | ENR curing |
| Examples | powder/g | nano-powder/g | powder/g | agent/g |
| Example 2 | 600 | 150 | 150 | 100 |
| Example 4 | 500 | 150 | 150 | 100 |
| Example 5 | 700 | 150 | 150 | 100 |
| Example 6 | 600 | 100 | 150 | 100 |
| Example 7 | 600 | 200 | 150 | 100 |
| Example 8 | 600 | 150 | 100 | 100 |
| Example 9 | 600 | 150 | 200 | 100 |
| Comparative | 0 | 150 | 150 | 100 |
| Example 1 | | | | |
| Comparative | 400 | 150 | 150 | 100 |
| Example 2 | | | | |
| Comparative | 800 | 150 | 150 | 100 |
| Example 3 | | | | |
| Comparative | 600 | 0 | 150 | 100 |
| Example 4 | | | | |
| Comparative | 600 | 50 | 150 | 100 |
| Example 5 | | | | |
| Comparative | 600 | 300 | 150 | 100 |
| Example 6 | | | | |
| Comparative | 600 | 150 | 0 | 100 |
| Example 7 | | | | |

### Performance Test

A wear resistance coefficient of the flexible material was tested with reference to the method of GB/T9867-2008 “Rubber, vulcanized or thermoplastic-Determination of abrasion resistance using a rotating cylindrical drum device” (rotation test). A tear strength of the flexible material was tested according to the method of ASTM D624-2000 “Standard Test Method for Tear Strength of Conventional Vulcanized Rubber and Thermoplastic Elastomers”. An elasticity of the flexible materials was tested according to the method of ASTM D1054-2002 “Standard Test Method for Rubber Property-Resilience Using a Goodyear-Healey Rebound Pendulum”. A folding number of the flexible material was measured according to the method of GB/T 1689-2009 “Rubber vulcanized-Determination of abrasion resistance (Akron machine)”. The specific results are shown in Table 2.

TABLE 2
Properties of different materials

| | | | Wearing | Folding number |
|---|---|---|---|---|
| | Tear | Elasticity | coefficient | (in ten |
| Examples | strength (N) | (%) | (%) | thousand) |
| Example 1 | 10 | 80 | 105 | 2.5 |
| Example 2 | 16 | 140 | 130 | 3.5 |
| Example 3 | 11 | 120 | 110 | 3.5 |
| Example 4 | 10 | 90 | 125 | 2.2 |
| Example 5 | 13 | 130 | 105 | 3.5 |
| Example 6 | 12 | 140 | 120 | 4 |
| Example 7 | 13 | 130 | 145 | 3 |
| Example 8 | 12 | 130 | 135 | 2.5 |
| Example 9 | 10 | 110 | 125 | 2 |
| Comparative | 5 | 60 | 105 | 0.5 |
| Example 1 | | | | |
| Comparative | 8 | 70 | 115 | 1.2 |
| Example 2 | | | | |
| Comparative | 6 | 110 | 110 | 1 |
| Example 3 | | | | |
| Comparative | 8 | 90 | 60 | 0.3 |
| Example 4 | | | | |
| Comparative | 7 | 100 | 85 | 0.6 |
| Example 5 | | | | |
| Comparative | 9 | 100 | 160 | 1.4 |
| Example 6 | | | | |
| Comparative | 6 | 40 | 115 | 1.1 |
| Example 7 | | | | |

From the results in Table 1, it can be seen that the flexible material prepared by the method according to the present disclosure has high tear strength, desirable elasticity, wear resistance, and folding endurance.

Regarding the tear strength and folding endurance of the flexible material:

The data of Example 2 and Comparative Example 1 show that the added waste rubber powder directly affects the tear strength and folding endurance of the flexible material, indicating that these properties are mainly imparted by the curing and cross-linking of rubber molecules in the waste rubber powder. Further combined with the data results of Examples 4 to 5 and Comparative Examples 2 to 3, it is fully demonstrated that the flexible material has excellent tear strength and folding endurance when preparing the same by addition of waste rubber powder in an amount of 50 parts to 70 parts by weight. However, if the addition amount of the waste rubber powder exceeds the above range, the tear strength and folding endurance of the flexible material are reduced. Especially, the addition amount of waste rubber powder in Comparative Example 3 is too high, and the tear strength of the flexible material is significantly reduced, which is due to the fact that the tear strength and folding endurance of flexible material are also affected by other preparation raw materials; and the waste polyester nano-powder and waste leather powder cooperates with the waste rubber powder to improve the tear strength and folding endurance of flexible material.

The above data results are further compared with the results of Comparative Example 4 and Comparative Example 7, and it is found that if the waste polyester nano-powder or waste leather powder is not added when preparing the flexible material, the tear strength of the flexible material is significantly reduced. This also proves the conclusion “the tear strength of flexible material is also affected by other preparation raw materials; and the waste polyester nano-powder and waste leather powder cooperate with the waste rubber powder to improve the tear strength of flexible material”.

Form the results of Examples 6 to 7 and Comparative Examples 5 to 6, it is found that if the addition amount of waste polyester nano-powder varies in a range of 10 parts to 20 parts by weight, there is little effect on the tear strength and folding endurance of the flexible material. It is recommended that the addition amount should be not too low, otherwise the performances are still significantly affected, especially the folding endurance of the flexible material. In addition, the results of Examples 8 to 9 show that if the amount of waste leather powder varies within a range of 10 parts to 20 parts by weight, a flexible material with better tear strength and bending resistance could be obtained.

Regarding the elasticity of the flexible material:

The waste rubber powder and its amount are the main influences on the elasticity of the flexible material, which lead to a large elastic difference between the flexible materials prepared in Example 2 and Comparative Examples 1 to 3. In addition, the data results of Comparative Example 7 also reflect that the addition of leather powder is highly important for the elasticity of the flexible material. Therefore, the cooperation of the waste rubber powder and waste leather powder mainly affects the elasticity of the flexible material.

Regarding the wear resistance of the flexible material:

The mechanical strength and wear resistance of the flexible material are improved by the addition of the waste polyester nano-powder, thus increasing a wear resistance coefficient. Therefore, the wear resistance coefficients of the flexible materials of Comparative Example 6 and Example 7 are higher, while the wear resistance coefficients of the flexible materials of Comparative Examples 4 to 5 are significantly reduced. The addition of other components and changes in their amounts cause little effect on the wear resistance coefficient of flexible material.

In short, the synergy between the raw materials of flexible material enables the flexible material to have excellent comprehensive properties.

The specific embodiments are only an explanation of the present disclosure, but do not limit the present disclosure. After reading this specification, those skilled in the art can make modifications to the embodiments as needed without creative contribution, and these modifications are protected by patent law as long as they fall within the scope of the claims of the present disclosure.

What is claimed is:

1. A flexible material based on resource utilization of waste finished leathers and waste fabrics, which is prepared from raw materials comprising the following components in parts by weight:
50 parts to 70 parts of a waste rubber powder, 10 parts to 20 parts of a waste polyester nano-powder, 10 parts to 20 parts of a waste leather powder, and 8 parts to 12 parts of an epoxidized natural rubber (ENR) curing agent.

2. The flexible material based on resource utilization of waste finished leathers and waste fabrics according to claim 1, wherein the waste rubber powder is prepared by a process comprising the following steps:
step 11, collecting a waste rubber, extracting the waste rubber by using supercritical carbon dioxide at a temperature of 30° C. to 40° C. under a pressure of 20 MPa to 30 MPa for 2 h to 4 h to obtain a primary rubber extract, and subjecting the primary rubber extract to vacuum distillation to recover a rubber solution, thereby obtaining a crude rubber product; wherein the supercritical carbon dioxide is further added with 0.5 vol. % to 2 vol. % of an emulsion solvent;
step 12, extracting the crude rubber product with another supercritical carbon dioxide at a temperature of 30° C. to 40° C. under a pressure of 20 MPa to 30 MPa for 2 h to 4 h to obtain a secondary rubber extract, and subjecting the secondary rubber extract to distillation to remove a solvent, thereby obtaining a refined rubber product; wherein the another supercritical carbon dioxide is further added with 0.5 vol. % to 2 vol. % of the emulsion solvent; and
step 13, subjecting the refined rubber product to cryogenic grinding in liquid nitrogen to obtain a ground rubber product, subjecting the ground rubber product to polycondensation in the emulsion solvent at a temperature of 60° C. to 100° C. for 2 h to 4 h, terminating the polycondensation to obtain a polycondensation product, and subjecting the polycondensation product to a post-treatment to obtain a rubber powder with a rubber molecular weight of 20,000 to 50,000;
wherein the emulsion solvent is selected from the group consisting of ethanol and acetone.

3. The flexible material based on resource utilization of waste finished leathers and waste fabrics according to claim 2, wherein the vacuum distillation in step 11 comprises:
filtering the primary rubber extract to obtain a precipitate and a filtrate, decompressing the precipitate at a temperature of 60° C. to 80° C. to an absolute pressure, heating the filtrate to boiling, adjusting a resulting gas phase to a temperature of 68° C. to 72° C. and a resulting liquid phase to a temperature of 76° C. to 80° C., and recovering an another solvent to obtain the crude rubber product in a form of a dry powder.

4. The flexible material based on resource utilization of waste finished leathers and waste fabrics according to claim 2, wherein for subjecting the secondary rubber extract to distillation to remove the solvent in step 12, the distillation is conducted by another vacuum distillation at a temperature of less than 80° C.

5. The flexible material based on resource utilization of waste finished leathers and waste fabrics according to claim 1, wherein the waste polyester nano-powder is prepared by a process comprising:
step 21, collecting a crushed waste polyester and mixing with a purification solvent to obtain a mixture, extracting the mixture at a temperature of 60° C. to 90° C. for 2 h to 4 h to obtain a polyester extract; wherein a mass ratio of the crushed waste polyester to the purification solvent is in a range of 1:(10-15);
step 22, filtering the polyester extract to obtain a precipitate, and subjecting the precipitate to solvent removal and drying in sequence to obtain a crude polyester powder;
step 23, mixing the crude polyester powder with an another purification solvent to obtain a blend, extracting the blend at a temperature of 60° C. to 90° C. for 0.5 h to 1 h to obtain a crude polyester powder extract; wherein a mass ratio of the crude polyester powder to the another purification solvent is in a range of 1:(10-15);
step 24, subjecting the crude polyester powder extract to solid-liquid separation to obtain an another precipitate, and subjecting the another precipitate to another solvent removal and another drying in sequence to obtain a preliminary purified polyester powder; and
step 25, repeating steps 23 to 24 until a polyester powder with uniform texture and appearance is obtained.

6. The flexible material based on resource utilization of waste finished leathers and waste fabrics according to claim 5, wherein the purification solvent or the another purification solvent is one or more selected from the group consisting of dichloromethane (DCM), trichloromethane (TCM), chloroform, and isopropyl alcohol.

7. The flexible material based on resource utilization of waste finished leathers and waste fabrics according to claim 1, wherein the waste leather powder is prepared by a process comprising: collecting the waste finished leathers and cotton fabrics, removing a fabric base layer, crushing a remaining surface leather matrix to obtain a crushed product, and sieving the crushed product to obtain the waste leather powder with 30 mesh to 50 mesh.

8. The flexible material based on resource utilization of waste finished leathers and waste fabrics according to claim 1, wherein the ENR curing agent is prepared from start materials comprising the following compositions in parts by weight:
45 parts to 55 parts of an epoxidized soybean oil, 45 parts to 55 parts of citric acid, 5 parts to 15 parts of a polyvinyl alcohol (PVA), 5 parts to 10 parts of a thickener, and 70 parts to 90 parts of an organic solvent.

9. The flexible material based on resource utilization of waste finished leathers and waste fabrics according to claim 1, wherein the ENR curing agent is prepared by a process comprising:
step 31, dissolving citric acid in an organic solvent to obtain a citric acid solution;
step 32, mixing the citric acid solution, a polyvinyl alcohol (PVA), a thickener, and an epoxidized soybean oil at a temperature of 50° C. to 70° C. under a speed of 8,000 rpm to 12,000 rpm, and subjecting a resulting mixture to emulsification to obtain an emulsion; and
step 33, stirring the emulsion at a temperature of 75° C. to 85° C. until the organic solvent evaporates to obtain a crude ENR curing agent; and subjecting the crude ENR curing agent to separation and drying to obtain the ENR curing agent.

10. A method for preparing the flexible material based on resource utilization of waste finished leathers and waste fabrics according to claim 1, comprising the following steps:
mixing the waste rubber powder, the waste polyester nano-powder, the waste leather powder, and the ENR curing agent according to proportions for 10 min to 20 min to obtain a rubber compound; and
subjecting the rubber compound to calendering or hot-pressed molding at a temperature of 110° C. to 130° C. to obtain a molding material, and curing the molding material for 10 min to 30 min to obtain the flexible material.

11. The method for preparing the flexible material based on resource utilization of waste finished leathers and waste fabrics according to claim 10, wherein the waste rubber powder is prepared by a process comprising the following steps:
step 11, collecting a waste rubber, extracting the waste rubber by using supercritical carbon dioxide at a temperature of 30° C. to 40° C. under a pressure of 20 MPa to 30 MPa for 2 h to 4 h to obtain a primary rubber extract, and subjecting the primary rubber extract to vacuum distillation to recover a rubber solution, thereby obtaining a crude rubber product; wherein the supercritical carbon dioxide is further added with 0.5 vol. % to 2 vol. % of an emulsion solvent;
step 12, extracting the crude rubber product with another supercritical carbon dioxide at a temperature of 30° C. to 40° C. under a pressure of 20 MPa to 30 MPa for 2 h to 4 h to obtain a secondary rubber extract, and subjecting the secondary rubber extract to distillation to remove a solvent, thereby obtaining a refined rubber product; wherein the another supercritical carbon dioxide is further added with 0.5 vol. % to 2 vol. % of the emulsion solvent; and
step 13, subjecting the refined rubber product to cryogenic grinding in liquid nitrogen to obtain a ground rubber product, subjecting the ground rubber product to polycondensation in the emulsion solvent at a temperature of 60° C. to 100° C. for 2 h to 4 h, terminating the polycondensation to obtain a polycondensation product, and subjecting the polycondensation product to a post-treatment to obtain a rubber powder with a rubber molecular weight of 20,000 to 50,000;
wherein the emulsion solvent is selected from the group consisting of ethanol and acetone.

12. The method for preparing the flexible material based on resource utilization of waste finished leathers and waste fabrics according to claim 11, wherein the vacuum distillation in step 11 comprises:
filtering the primary rubber extract to obtain a precipitate, decompressing the precipitate at a temperature of 60° C. to 80° C. to an absolute pressure, then heating to boiling, adjusting a resulting gas phase to a temperature of 68° C. to 72° C. and a resulting liquid phase to a temperature of 76° C. to 80° C., and recovering an another solvent to obtain the crude rubber product in a form of a dry powder.

13. The method for preparing the flexible material based on resource utilization of waste finished leathers and waste fabrics according to claim 11, wherein for subjecting the secondary rubber extract to distillation to remove the solvent in step 12, the distillation is conducted by another vacuum distillation at a temperature of less than 80° C.

14. The method for preparing the flexible material based on resource utilization of waste finished leathers and waste fabrics according to claim 10, wherein the waste polyester nano-powder is prepared by a process comprising:
step 21, collecting a crushed waste polyester and mixing with a purification solvent to obtain a mixture, extracting the mixture at a temperature of 60° C. to 90° C. for 2 h to 4 h to obtain a polyester extract; wherein a mass ratio of the crushed waste polyester to the purification solvent is in a range of 1:(10-15);
step 22, filtering the polyester extract to obtain a precipitate, and subjecting the precipitate to solvent removal and drying in sequence to obtain a crude polyester powder;
step 23, mixing the crude polyester powder with an another purification solvent to obtain a blend, extracting the blend at a temperature of 60° C. to 90° C. for 0.5 h to 1 h to obtain a crude polyester powder extract; wherein a mass ratio of the crude polyester powder to the another purification solvent is in a range of 1:(10-15);
step 24, subjecting the crude polyester powder extract to solid-liquid separation to obtain an another precipitate, and subjecting the another precipitate to another solvent removal and another drying in sequence to obtain a preliminary purified polyester powder; and
step 25, repeating steps 23 to 24 until a polyester powder with uniform texture and appearance is obtained.

15. The method for preparing the flexible material based on resource utilization of waste finished leathers and waste fabrics according to claim 14, wherein the purification solvent or the another purification solvent is one or more selected from the group consisting of dichloromethane (DCM), trichloromethane (TCM), chloroform, and isopropyl alcohol.

16. The method for preparing the flexible material based on resource utilization of waste finished leathers and waste fabrics according to claim 10, wherein the waste leather powder is prepared by a process comprising: collecting the waste finished leathers and cotton fabrics, removing a fabric base layer, crushing a remaining surface leather matrix to obtain a crushed product, and sieving the crushed product to obtain the waste leather powder with 30 mesh to 50 mesh.

17. The method for preparing the flexible material based on resource utilization of waste finished leathers and waste fabrics according to claim 10, wherein the ENR curing agent is prepared from start materials comprising the following compositions in parts by weight:
45 parts to 55 parts of an epoxidized soybean oil, 45 parts to 55 parts of citric acid, 5 parts to 15 parts of a polyvinyl alcohol (PVA), 5 parts to 10 parts of a thickener, and 70 parts to 90 parts of an organic solvent.

18. The method for preparing the flexible material based on resource utilization of waste finished leathers and waste fabrics according to claim 10, wherein the ENR curing agent is prepared by a process comprising:
step 31, dissolving citric acid in an organic solvent to obtain a citric acid solution;
step 32, mixing the citric acid solution, a polyvinyl alcohol (PVA), a thickener, and an epoxidized soybean oil at a temperature of 50° C. to 70° C. under a speed of 8,000 rpm to 12,000 rpm, and subjecting a resulting mixture to emulsification to obtain an emulsion; and
step 33, stirring the emulsion at a temperature of 75° C. to 85° C. until the organic solvent evaporates to obtain a crude ENR curing agent; and subjecting the crude ENR curing agent to separation and drying to obtain the ENR curing agent.

19. The flexible material based on resource utilization of waste finished leathers and waste fabrics according to claim 8, wherein the thickener is selected from the group consisting of guar gum and gum Arabic.
